(19) United States
(12) Patent Application Publication
(10) Pub. No.: US 2009/0033917 A1
(43) Pub. Date: Feb. 5, 2009

(54) Optical Object Detection System for Non-Circular Orbits

(75) Inventors: Donald J. Bak, Streamwood, IL (US); Patanit Sanpitak, Highland Park, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/833,618

(22) Filed: Aug. 3, 2007

(51) Int. Cl. G01N 21/00

(52) U.S. Cl. 356/73

(57) ABSTRACT

Systems and methods for dynamically positioning a detector relative to an object are provided. In one respect, a light source may project a light energy forming at least one projected plane onto a light rail, and more particularly, a light guide embedded in the light rail. The light energy of the projection may be obtained and may be differentially compared to a reference light energy obtained by a photo detector. Based on the differentially comparison, a detector may be positioned, i.e., closer to the object, away from the object, or maintaining the current position.

This application incorporates by reference in its entirety to U.S. patent application having a docket number of 2007P16539US, entitled “Multi-Level Light Curtain with Structure Light Sources and Imaging Sensors,” by Patanit Sanpitak, filed on Aug. 3, 2007.

### TECHNICAL FIELD

The invention relates to imaging processing, and in particular, feedback systems and methods for detecting an obstruction in a detection area.

### BACKGROUND

Nuclear medical imaging is widely used due to the ease of collecting multiple data sets simultaneously during an imaging period. Emissions of a distributed radioactive tracer inside an organism are collected by detectors, converted into signals, and used to generate a complete image of the organism.

Generally, in single photon emission computerize tomography (SPECT), also referred to as a gamma camera system, scintillation detectors are placed relatively close to a patient during the image acquisition process. In some respects, light rails may be placed along each side of a scintillation detector surface to provide feedback signals to a motion control system that can automatically position the scintillation detectors at the closest proximity between the detector's surface and an object being imaged, such as a patient. The placement is important as the closer the detector is to the patient, the better the image quality. Also, maintaining a patient's safety is important with respect to the detector's placement. The detectors can each weigh upwards of 1000 pounds. Therefore, the placement of the detector in proximity of the patient is such that any contact with the patient may trigger a touch sensor and shut down the motion of the detectors.

Current SPECT systems employ a two level light rail system that includes arrays of infrared light emitting diodes (IR LEDs). Because each IR LED transmits its beam in a wedge shape across the surface of a detector collimator, several IR LEDs may be arranged on both sides of the light rails in light transmitter and receiver such that all wedge beams can interleave and generate a continuous plane over the surface of the detector collimator. Generally, the IR LEDS and IR photodiodes may be sequentially scanned by a microcontroller for real-time sensing response as well as well as to prevent cross-talk between each light plane.

However, component parametric variations including sensitivity of the photodiodes and light intensity of the IR LEDs require component sorting and complex calibration scheme in order to function properly. Additionally, tight tolerance is required to assemble the IR LEDs and IR photodiodes on long printed circuit boards (PCBs) to meet the specified light plane sensitivity. Further, the PCBs are difficult to manufacture and handle.

Aside from the hardware limitations of current SPECT implementations, factors such as signal connection reliability may be compromised due to a large number of signal interfaces that are needed between the light rails and the microcontroller.

### SUMMARY

In accordance with the teachings of the present disclosure, disadvantages and problems associated with existing light rails in imaging systems may be substantially reduced or eliminated. The present disclosure provides system and method for dynamically detecting an obstruction in a detection area. In one respect, a method for detecting an obstruction across a detection area is provided. The method may include projecting a plane across substantially a first portion of the detection area onto a light guide. The light energy received by the light guide may subsequently be guided to a photo detector, and the projected plane, and more particularly the electromagnetic or light energy may be evaluated.

The method may also provide evaluating light energy of a second portion the detection plane to determine a reference light energy, which may subsequently be differentially compared with the light energy of the projected plane to determine an obstruction in the detection area.

In some respects, a dual plane configuration may be provided. A first plane may be projected across a portion of the detection area and the light energy may be obtained. A second plane may also be projected across a similar portion of the detection area and a light energy may be obtained. The light energies from the first and second planes may be differentially compared with a reference light energy to determine an obstruction in the detection area.

It is understood that the methods of the present disclosure may include instructions that may be executed on a tangible computer media.

The present disclosure also provides a system comprising a detection system and a processor coupled to the detection system. The detection system may include, without limitation, a light source, at least one light guide embedded in a light rail, and a reference photo detector. The light guide may be operably configured to receive light from the light source and guide the light to at least one photo detector embedded in the light rail. The reference photo detector may sample light from a portion of the detection area, and both light energies (e.g., the reference light energy sampled by the reference photo detector and the light energy received by the photo detector embedded in the light rail) may be differentially evaluated by the processor.

### BRIEF DESCRIPTION OF THE DRAWINGS

The embodiments will be explained in greater detail in the text which follows by means of diagrammatically represented embodiments in the drawing without the invention being restricted to these embodiments.

FIG. 1 shows a detection system, in accordance with embodiments of the present disclosure.

FIG. 2 shows a single plane configuration of the system shown in FIG. 1, in accordance with embodiments of the present disclosure.

FIG. 3 shows a dual-plane configuration of the system shown in FIG. 1, in accordance with embodiments of the present disclosure.

FIG. 4 shows a dual-plane configuration of the system shown in FIG. 1, in accordance with embodiments of the present disclosure.

FIG. 5 shows a flowchart for a method, in accordance with embodiments of the present disclosure.

### DETAILED DESCRIPTION

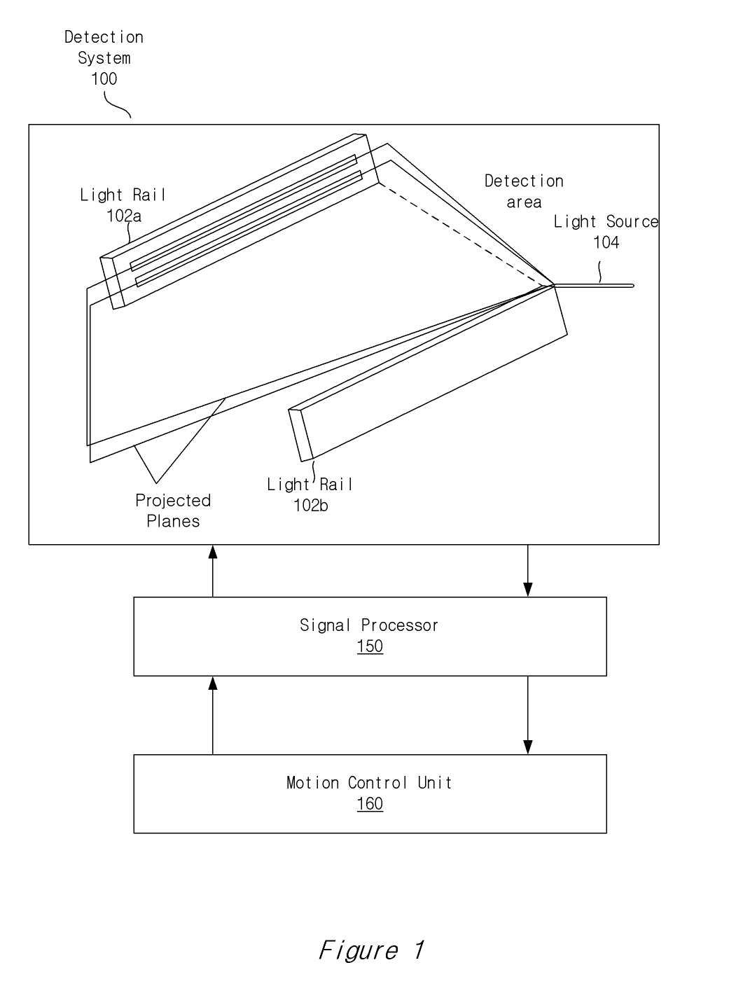

Preferred embodiments and their advantages are best understood by reference to FIGS. 1 through 5, wherein like numbers are used to indicate like and corresponding parts.

The present disclosure provides an improvement in light rail design in a non-circular orbit that may be used, for example, in medical imaging systems. Referring to FIG. 1, detection system 100 is shown. Detection system 100 includes light rails 102a and 102b (collectively, light rails 102). In one respect, light rail 102a may be spaced apart from light rail 102b by a detection area, i.e., the area to detect whether an object is too close or too far from the detectors and/or the area where an image of the object is captured.

Detection system 100 also includes light source 104, such as a line light source or other suitable electromagnetic light sources known in the art, coupled to light rail 102b. It is noted that light source 104 may also be coupled to light rail 102a, or alternatively, a light source may be provided for each light rail. It is also noted that detection system 100 may include one or more light sources. For example, one or more light sources may be added if necessary to provide coverage across the detection area. The light source(s) may either be multiplexed or modulated by a separate carrier as needed to carry avoid co-channel interference.

In operation, light source 104 may project at least one plane, and in some embodiments, two planes across the detection area. To determine the distance of detector system 100 relative to an object being imaged, the detector may utilize the object's position between the two projected planes. In other words, the distance of the detector to the object may be controlled by maintaining the position of the object between the two projected planes of light source 104.

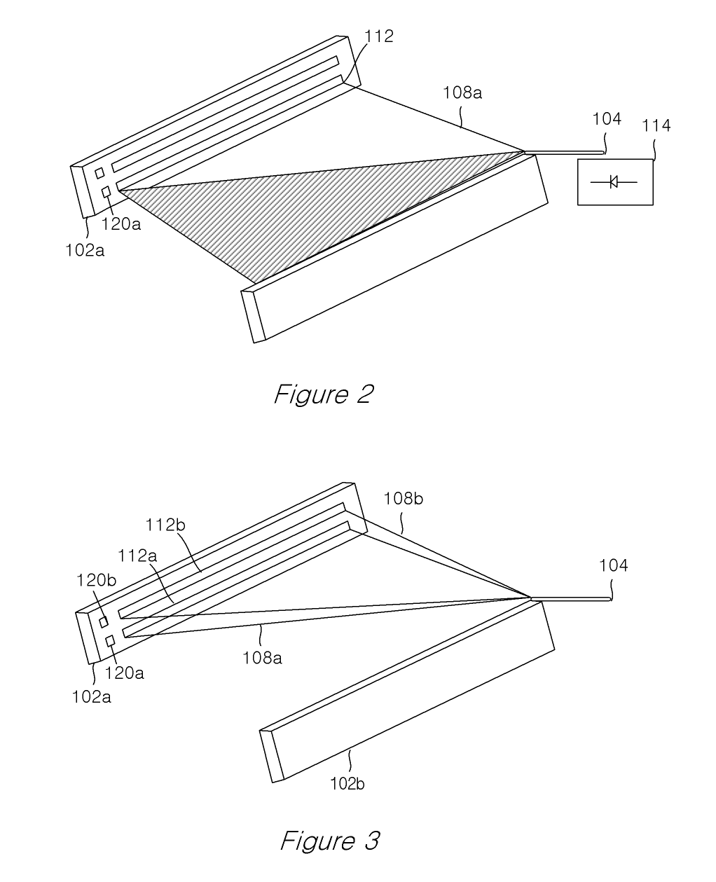

In one respect, light source 104 may be a low power laser with line generator optics which may project a plane, such as, lower plane 108a that may intersects an object during scanning, as seen in FIG. 2, which illustrates a detailed system diagram of detection system 100 in operation. In particular, a fan beam from light source 104 may be projected and may strike light guide 112 embedded in light rail 102b. Light guide 112 may be made of a plastic or glass with a polished edge. The fan beam from light source 104 may enter an edge of light guide 112 and a portion of the light may be guided to and received by photo detector 120a coupled to light guide 112.

In some respects, a dual light plane embodiment may be used. Referring to FIG. 3, light source 104 may include a dual line laser module that may project a lower plane 108a that may be received by light guide 112a and an upper plane 108b that may be received by light guide 112b. For example, a two line laser module, such as one or more Apinex Module LN-60 line lasers (Montreal, Canada) may be used to project the two separate planes. The laser modules may be vertically separated to generate the two (2) lines that project as two separate planes, such as planes 108a and 108b of FIG. 3. The light planes received by the light guide 112a and 112b and may be subsequently guided to photo detector 120a and 120b, respectively.

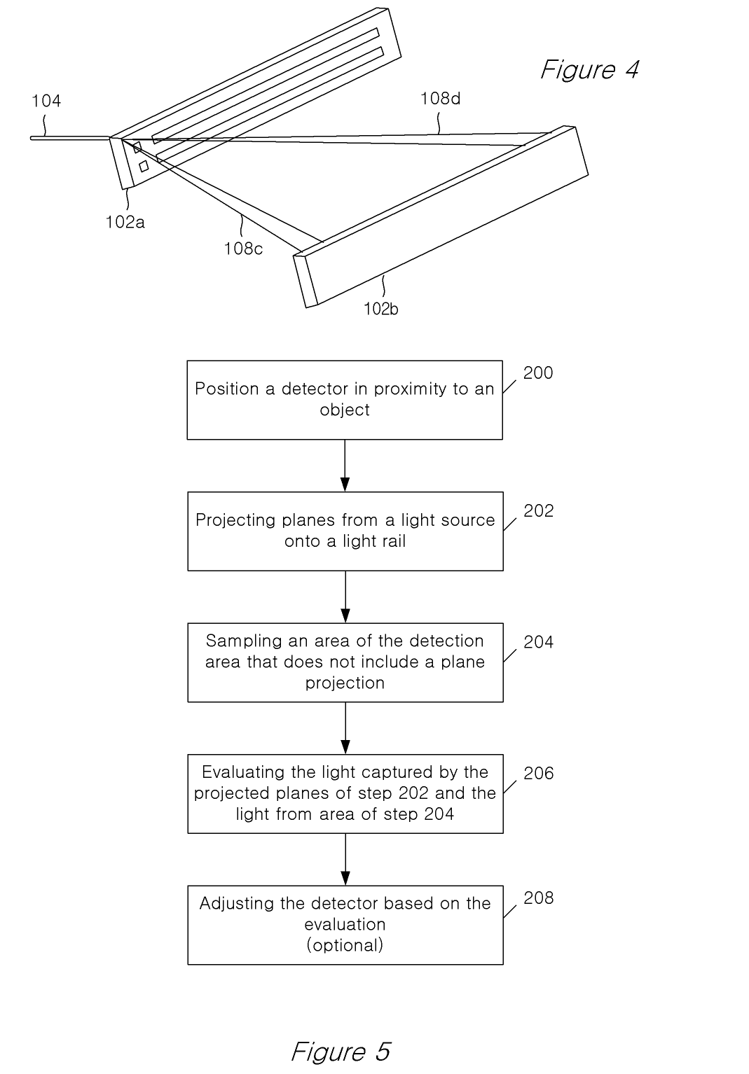

As seen in FIGS. 2 and 3, planes projected by light source 104 may cover approximately a portion, and in some embodiments, one half of the detection area. Therefore, an object that crosses the detection area may not intersect with a projected plane and may go unnoticed. Therefore, other portions of the detection area may need to be evaluated. Referring to FIG. 4, a second light source 104a coupled to light rail 102a may be used to project light planes covering substantially another portion of the detection area, and in some embodiments, a second half of the detection area. Light source 104a may project a single plane (either 108c or 108d) onto light rail 102b, and in particular a light guide embedded in the light rail. Alternatively, light source 104a may project a dual plane configuration where lower plane 108c may be received by a first light guide and upper plane 108d may be received by a second light guide of light rail 102b. The light or electromagnetic energy received by the light guides of light rail 102b, and in particular a photo detector of the light guides may be used to evaluate a position of an object relative to the detector system.

The light received at either photo detector 120a and 120b (and similar component(s) in housing 102b) may be processed into an image and may subsequently compared with a reference image. A reference image may be obtained by sampling the detection area when light source 104 is not in operation, i.e., light source 104a may not be on. Alternatively, a reference image may be obtained by sampling an area not covered by a projected plane. For example, referring to FIG. 2, the hashed portion of the detection area may not include a projected light plane. This area may be imaged and may be used as a reference image. In one embodiment a reference photo detector (not shown) may be coupled to the light source and may be used to sample portion of the detection area that does not include the projected planes (e.g., hashed area of FIG. 2) and the received light or electromagnetic energy may be processed into a reference image. The reference photo detector may include a photodiode which may sample a portion of the detection area. Alternatively or in addition, light guides 112 and photo detectors 120 in light rail 102a, or similar components embedded in light rail 102b may be used to capture the ambient light of the detection area before a light plane is projected or during the projection of a light plane, and may subsequently be converted into a reference image. The reference image and an image of the projected line(s) may be used to determine the positioning of a detector. For example, if the light energy of the projected line(s) received at the light guide is smaller than the reference image, an object may be partially or totally blocking the detection area, and the detectors may be moved away from the object. Alternatively, if the light energy of the projected line(s) is substantially similar to the light energy of the sampled area of the detection plane, this may indicate an object may not be protruding into the detection area or touching the detectors. The detectors may be positioned closer to the object or remain in the position at the time the obstruction analysis was performed.

Referring to FIG. 5, steps for determine the placement and adjustment of the detectors of the systems shown in FIG. 1-4 are shown. The technique shown in FIG. 5 may provide a dynamic feedback to a motion control unit (e.g., motion control unit 160 coupled to signal processor 150 of FIG. 1) to adjust the position detection system 100 relative to an object being imaged. In particular, when an object obstructs the light plane or is too close to or is touching the detector, the projected line or lines may be broken. The obstruction may reduce the light energy received by the photo detectors, and may result in the movement or adjustments of the detectors by the motion control processing system.

In one respect, a detector system may be positioned using a motion controller (e.g., motion control unit 160 of FIG. 1) in proximity to the object (step 200). The detectors may be aligned before and/or after the object is situated.

In step 202 of FIG. 5, a line from one or more laser modules may be projected onto an opposing light rail forming a plane. In one respect, only one plane may be projected. Alternatively, the projection may include a projection from one or more laser module. For example, two lines may be projected from a dual laser module forming two plane projections across the detection area onto an opposing light rail. A light guide embedded in the light rail, similar to light guides 112 of FIGS. 2 through 4 may capture the light from the projected planes. A photo detector coupled to the light guide may receive the light due to internal refraction properties of the light guide.

In step 204, an area not being covered by the projected lines of step 202 may be evaluated. In one embodiment, a photo detector may be used to sample the area that does not include a projected plane. For example, a photo detector coupled to the light source may be used to capture the reference light. Alternatively or in addition, the light guides and photo detectors of the rails may be used to collect the reference light. The light captured by the photo detector may subsequently be processed and a reference image may be generated.

It is noted that step 204 may be performed prior to step 200 or 202 such that the ambient light of the detection area, prior to the projecting of lines may be captured and processed as a reference image.

Next, the captured light or electromagnetic energy from the photo detector (from both step 202 and 204) may be evaluated in step 206 followed by a possible adjustment of the detector's position in step 208. In one embodiment, a processor (e.g., processor 150 coupled to detection system 100 of FIG. 1) may evaluate the captured projected lines to determine if the projected lines are broken, i.e., an object is obstructing the line projections from the laser modules. The broken lines may result in a reduced light energy received by the photo detectors. The processor may subsequently differentially process the light received by the light guide and the light received from steps 202 and 204. It is noted that the differential mechanism of the signal processor may reduce the sensitivity to variations in light intensity, electronic drift, and improve sensitivity to the object's blockage.

In optional step 208, the position of the detector may be adjusted. The position of the detector relative to the object may depend on whether one or all of the projected lines are obstructed. For example, in an embodiment where two lines are projected, both lines may be evaluated. If both lines are broken, the light energy may be reduced, and the object may be too close to detector and may interfere with the imaging process. If both lines are not broken, the detector may not be close enough to an object and may need to be repositioned. If only one line is broken, the detector's position may be situated as close as possible to the object. As such, in step 208, the detector may remain as positioned in step 200.

As used in this disclosure, “tangible computer readable media” means any instrumentality, or aggregation of instrumentalities that may retain data and/or instructions for a period of time. Tangible computer readable media may include, without limitation, random access memory (RAM), read-only memory (ROM), electrically erasable programmable read-only memory (EEPROM), a PCMCIA card, flash memory, direct access storage (e.g., a hard disk drive or floppy disk), sequential access storage (e.g., a tape disk drive), compact disk, CD-ROM, DVD, and/or any suitable selection of volatile and/or non-volatile memory and/or storage.

The computer-readable media may be embodied internally or externally on a hard drive, ASIC, CD drive, DVD drive, tape drive, floppy drive, network drive, flash drive, USB drive or the like. Further, the computer-readable media may be any computing device capable of executing instructions for implementing the method shown, for example, in FIG. 5. In one embodiment, the computer-readable media may be a processor or a personal computer (e.g., a typical desktop or laptop computer operated by a user). In other embodiments, a computer-readable media may be a personal digital assistant (PDA) or other handheld computing device.

In some embodiments, the computer-readable media may be a networked device and may constitute a terminal device running software from a remote server, wired or wirelessly. Input from a user or system components may be gathered through one or more known techniques such as a keyboard and/or mouse. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The computer readable-media may use any type of monitor or screen known in the art, for displaying information. For example, a cathode ray tube (CRT) or liquid crystal display (LCD) can be used. One or more display panels may also constitute a display. In other embodiments, a traditional display may not be required, and computer readable-media may operate through appropriate voice and/or key commands.

What is claimed is:

1. A method for detecting an obstruction across a detection area, the method comprising:
projecting a plane onto a light guide comprising a first photo detector, the projected plane covering substantially a first portion of the detection area;
obtaining the light energy from the projected plane;
evaluating the light energy from the projected plane;
evaluating a second portion of the detection area with a second photo detector to determine a reference light energy; and
differentially comparing light energy of the projected plane and the reference light energy to determine an obstruction in the detection area.

2. The method of claim 1, wherein projecting a plane comprises projecting a lower plane onto a first light guide and an upper plane onto a second light guide.

3. The method of claim 2, wherein the first light guide and the second light guide are both embedded in a light rail.

4. The method of claim 3, wherein projecting a plane comprises projecting a first plane onto a light guide of a first light rail and projecting a second plane onto a light guide of a second light rail.

5. The method of claim 1, wherein projecting a plane comprises projecting a dual plane, the dual plane comprising an upper plane and a lower plane.

6. The method of claim 1, wherein projecting a plane comprises projecting a fan beam across the detection area.

7. The method of claim 6, wherein projecting the fan beam comprises projecting the fan beam over the first portion of the detection area.

8. A method comprising:
projecting a first plane onto a first light guide, the projected plane covering substantially a first portion of the detection area;
obtaining a light energy of the first projected plane;
projecting a second plane onto a second light guide, the projected plane covering substantially the first portion of the detection area;
obtaining a light energy of the second projected plane;
obtaining a reference light energy; and
differentially comparing light energy from the first projected plane, the light energy from the second plane, and reference light energy to determine an obstruction in the detection area.

9. The method of claim 8, wherein the first light guide and the second light guide are embedded into a light rail.

10. The method of claim 8, further comprising projecting a third plane onto a third light guide and forth plane onto a fourth light guide, the third and forth light guides being parallel to the first and second light guides.

11. The method of claim 8, wherein the second portion of the detection area comprises the first portion of the detection area.

12. The method of claim 8, wherein projecting the first plane and the second plane comprising projecting a fan beam across the detection area.

13. The method of claim 8, further comprising adjusting a position of a detector based on the differential comparison.

14. A system comprising:
a detection system comprising:
a light source;
at least one light guide embedded in a light rail coupled to the light source, the at least one light guide operably configured to receive light from the light source and guide the light to at least one photo detector embedded in the light rail;
a reference photo detector coupled to the light source for sampling light from a portion of a detection area; and
a processor coupled to the detection system for differentially evaluating light signals received by the at least one light guide and reference photo detector.

15. The system of claim 14, wherein the light source comprises a line light source.

16. The system of claim 14, wherein the light source comprises two line light source.

17. The system of claim 14, wherein the at least one light guide embedded in a light rail comprises at least one light guide embedded in a first light rail and at least one light guide embedded in a second light rail, the first light rail and the second light rail being spaced apart.

18. The system of claim 14, wherein the at least one light guide comprises a glass light guide or a plastic light guide.

19. The system of claim 14, wherein the reference photo detector comprises the at least one photo detector embedded in the light rail.

20. The system of claim 14, further comprising a motion control unit coupled to the processor for adjusting the detection system relative to an object based on the evaluation of the control processor.
